(19) United States
(12) Patent Application Publication
(10) Pub. No.: US 2021/0229954 A1
(43) Pub. Date: Jul. 29, 2021

(54) BUILDING MANAGEMENT SYSTEM FOR EFFECTIVE RESCUING DURING FIRE EVACUATION

(71) Applicant: Carrier Corporation, Palm Beach Gardens, FL (US)

(72) Inventors: Prasad Babu Lakshmipathy, Hyderabad, Telangana (IN); Sudharshan Karanam, Hyderabad, Telangana (IN); Rajinikanth Pusala, Hyderabad, Telangana (IN)

(21) Appl. No.: 15/733,858

(22) PCT Filed: Aug. 29, 2019
(86) PCT No.: PCT/US2019/048865

§ 371 Date: Nov. 30, 2020

(30) Foreign Application Priority Data
Sep. 14, 2018 (IN) 201811034758

(51) Int. Cl. B66B 5/02; B66B 1/34; H04N 5/33; H04N 7/18

(52) U.S. Cl. CPC B66B 5/024; H04N 7/181; H04N 5/33; B66B 1/3461

(57) ABSTRACT

A system (100) for generating a thermal profile of a building is provided. The building includes an elevator (102) and a corresponding counterweight (103) within a hoistway (101). The system includes a facility management subsystem (130) and detection devices (136, 138). The facility management subsystem (130), in response to receiving an alarm, causes the elevator to automatically travel to one or more floors of the building and instructs the detection devices (136, 138) to collect images of one or more elevator lobbies of the building or the hoistway with respect to the elevator automatically traveling to the one or more floors. The facility management subsystem (130) generates a thermal profile based on the images.

### BACKGROUND

Current fire evacuation systems generate and provide alarm and fire location information to current building management systems. Accordingly, current building management systems govern elevators in response to the alarm and fire information by moving the elevators to designated discharge areas. Fire marshals may then utilize the elevators to perform rescues.

Unfortunately, at present, current fire evacuation systems and current building management systems have no way of providing thermal profiles of elevator hoistways, which is a safety concern for the fire marshals who use the elevators to perform the rescues. For example, a lack of thermal profiles of elevator hoistways may cause delays in performing evacuations and/or fire suppression.

### BRIEF DESCRIPTION

In accordance with one or more embodiments, a system is provided. The system generates a thermal profile of a building. The building includes at least one elevator and at least one corresponding counterweight within a hoistway. The system includes a facility management subsystem and one or more detection devices. The system, in response to receiving an alarm, causes the at least one elevator to automatically travel to one or more floors of the building and instructs the one or more detection devices to collect one or more images of one or more elevator lobbies of the building or the hoistway with respect to the at least one elevator automatically traveling to the one or more floors. The system generates a thermal profile based on the one or more images.

In accordance with one or more embodiments or the system embodiment above, the one or more detection devices can include a first camera located on a first elevator of the at least one elevator and a second camera located on a counterweight corresponding to the first elevator.

In accordance with one or more embodiments or any of the system embodiments above, the facility management subsystem can upload the one or more images and the thermal profile to a database.

In accordance with one or more embodiments or any of the system embodiments above, the facility management subsystem can provide the thermal profile to a mobile device for evaluation of the alarm.

In accordance with one or more embodiments or any of the system embodiments above, the facility management subsystem can receive instructions to capture additional images.

In accordance with one or more embodiments or any of the system embodiments above, the facility management subsystem can instruct the one or more detection devices to collect the additional images in accordance with the instructions from the mobile device.

In accordance with one or more embodiments or any of the system embodiments above, the facility management subsystem can cause the at least one elevator to travel to the one or more floors to collect the additional images in accordance with the instructions from the mobile device.

In accordance with one or more embodiments or any of the system embodiments above, the facility management subsystem can provide the additional images to the mobile device for further evaluation of the alarm.

In accordance with one or more embodiments or any of the system embodiments above, the one or more detection devices can be thermographic cameras generating heat zone images as the one or more images using infrared radiation from the one or more elevator lobbies of the building or the hoistway.

In accordance with one or more embodiments or any of the system embodiments above, the alarm can be a fire alarm generated by a fire subsystem in communication with the facility management subsystem.

In accordance with one or more embodiments, any of the above system embodiments can be implemented as a method and/or computer program product.

### BRIEF DESCRIPTION OF THE DRAWINGS

The following descriptions should not be considered limiting in any way. With reference to the accompanying drawings, like elements are numbered alike:

FIG. 1 depicts a system for flashing firmware in accordance with one or more embodiments;

FIG. 2 depicts a process flow of a system in accordance with one or more embodiments; and

FIG. 3 depicts a schematic flow of the system for flashing firmware in accordance with one or more embodiments.

### DETAILED DESCRIPTION

A detailed description of one or more embodiments of the disclosed apparatus and method are presented herein by way of exemplification and not limitation with reference to the Figures.

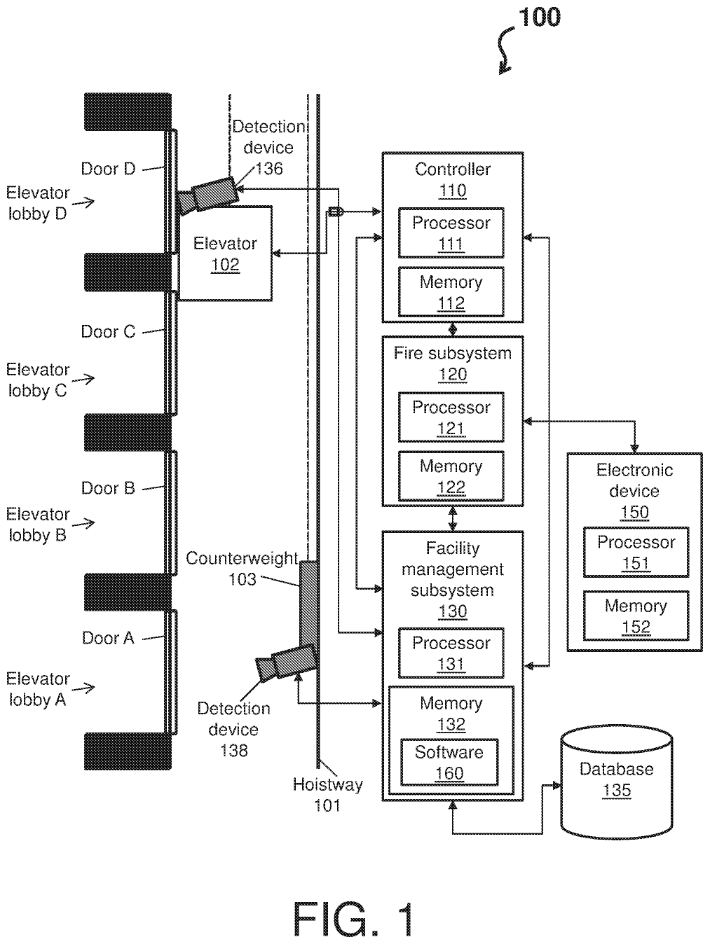

FIG. 1 depicts a system 100 for generating a thermal profile of a building in accordance with one or more embodiments, which can be realized as methods and/or computer program products. The system 100 overlays a facility. The facility can be any building, structure, campus, park, complex, parking facility, amusement park, stadium, etc. or combination thereof. For example, the facility comprises one or more floors with corresponding elevator lobbies A, B, C, and D having corresponding doors A, B, C, and D. The doors A, B, C, and D are elevator doors that provide access to a hoistway 101 in which an elevator 102 travels. The facility is utilized as an illustration of a complexity of the system 100, in that the system 100 can stretch across a vast area in any direction, which exacerbates the disadvantages of performing rescues.

As shown in FIG. 1, the system 100 includes a controller 110 (comprising a processor 111 and a memory 112), a fire subsystem 120 (comprising a processor 121 and a memory 122), a facility management subsystem 130 (comprising a processor 131 and a memory 132) coupled to a database 135 and one or more detection devices (e.g., a detection device 136 and a detection device 138), and an electronic device 150 (comprising a processor 151 and a memory 152).

The system 100 and elements therein may take many different forms and include multiple and/or alternate components and facilities. The system 100 is only one example and is not intended to suggest any limitation as to the scope of use or operability of embodiments described herein (indeed additional or alternative components and/or implementations may be used). While single items are illustrated for the system 100 (and other items), these representations are not intended to be limiting and thus, any items may represent a plurality of items.

The controller 110, the fire subsystem 120, the facility management subsystem 130, and the electronic device 150 are computing devices that are improved upon by the operation and functionality of the embodiments described herein. Each respectively includes one of the processors 111, 121, 131, and 151 and one of the memories 112, 122, 132, and 152 with software stored thereon. For example, the facility management subsystem 130 is improved upon by the operation and functionality of software 160.

The controller 110 can be an elevator control system that manages the operations of the elevator 102. For instance, the controller 110 can direct the elevator 102 to travel to one or more floors of the building. The controller 110 can position the elevator 102 in accordance with a predefined scheme or in accordance with instructions from the facility management subsystem 130. In the case of an alarm, such as a fire emergency, controller 110 can cause the elevator 102 to stop at designated discharge area for passenger evacuation.

The fire subsystem 120 can be an alarm scheme including devices for detecting and warning users of smoke, fire, carbon monoxide, or other emergencies are present. The fire subsystem 120 can be activated from smoke detectors, heat detectors, or manual devices. The fire subsystem 120 can send an alarm, e.g., a fire alarm, as a signal to the facility management subsystem 130.

The facility management subsystem 130 can be a computer control scheme that controls and monitors a facility's mechanical and electrical equipment, such as ventilation, lighting, power, and security systems. For instance, the facility management subsystem 130, through the one or more detection devices 136, 138, can remotely and dynamically get live thermal details of the elevator lobbies A, B, C, and D and the hoistway 101. In turn, the facility management subsystem 130 can communicate, in the form of a thermal profile, fire intensity at different floor areas to emergency personnel and guide occupants of the facility to safest refugee area.

The thermal profile is a dataset compiled by the facility management subsystem 130 based on images captured by the detection devices 136, 138. The thermal profile can include data, such as temperature, humidity, timestamps, locations, and pressure per lobby A, B, C, and D and the hoistway 102, each of which can be extracted from the images or detection by sensors included in the detection devices 136, 138. The thermal profile can be display through any number of graphic user interfaces so that effective, quick, and accurate evacuation and fire suppression planning can be accomplished.

The database 135 electronically collects and stores for access by the facility management subsystem 130 and other elements of the system 100 data, such as images and thermal profiles. In this regard, the thermal profile, images, and any information associated therewith can be transferred to and from the database 135 through the facility management subsystem 130.

The detection device 136 and the detection device 138 can be any transducer or combination of transducers for capturing environmental conditions of the facility. In accordance with one or more embodiments, the detection devices 136, 138 are cameras that automatically capture snapshots of the elevator lobbies A, B, C, and D or the hoistway 101 during an elevator run. For instance, the detection device 136 and the detection device 138 can be thermographic cameras generating heat zone images, using infrared radiation, of the elevator lobbies A, B, C, and D or the hoistway 101. The detection device 136 can be a first camera located on the elevator 102, and the detection device 138 can be a second camera located on the counterweight 103 corresponding to the first elevator. The detection devices 136, 138 can be mounted on a movable stand, with actuators that can change the sensing or viewing angle thereof

The electronic device 150 can be a remote user or mobile device, such as a smartphone, laptop, or tablet, which is in communication with the facility management subsystem 130 and other elements of the system 100. The electronic device 150 can include a display for providing the thermal profile generated by the facility management subsystem 130 and/or any images captured by the detection devices 136, 138.

The processors 111, 121, 131, and 151 include any processing hardware, software, or combination of hardware and software that carries out the computer readable program instructions by performing arithmetical, logical, and/or input/output operations. Examples of the processors 111, 121, 131, and 151 include, but are not limited to an arithmetic logic unit, which performs arithmetic and logical operations; a control unit, which extracts, decodes, and executes instructions from a memory; and an array unit, which utilizes multiple parallel computing elements.

The memories 112, 122, 132, and 152 are examples of a tangible device that retains and stores computer readable program instructions or at least one program product (e.g., the software 160) for use by the processors 111, 121, 131, and 151 to carry out the operations of embodiments herein. The memories 112, 122, 132, and 152 can include a variety of computer system readable media. Such media may be any available media that is accessible and it includes both volatile and non-volatile media, removable and non-removable media.

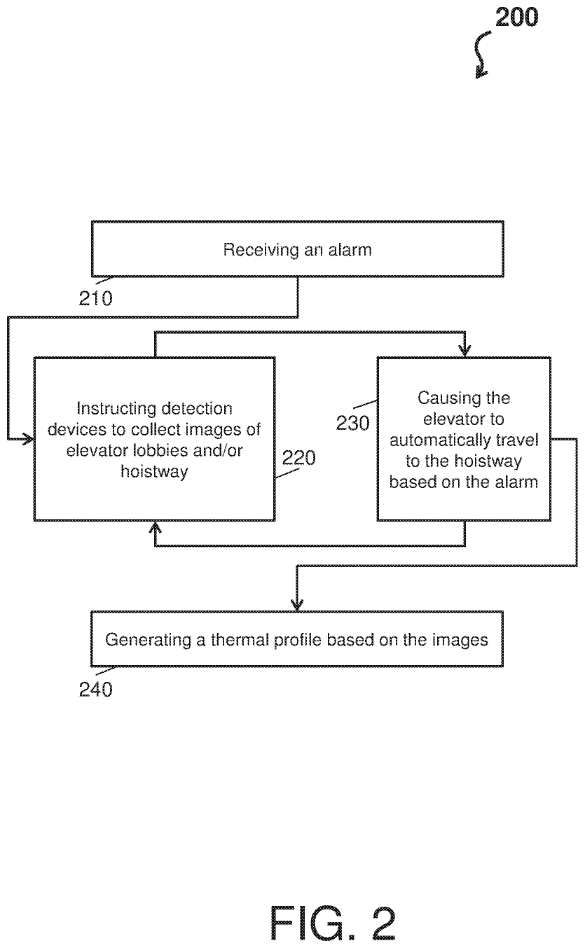

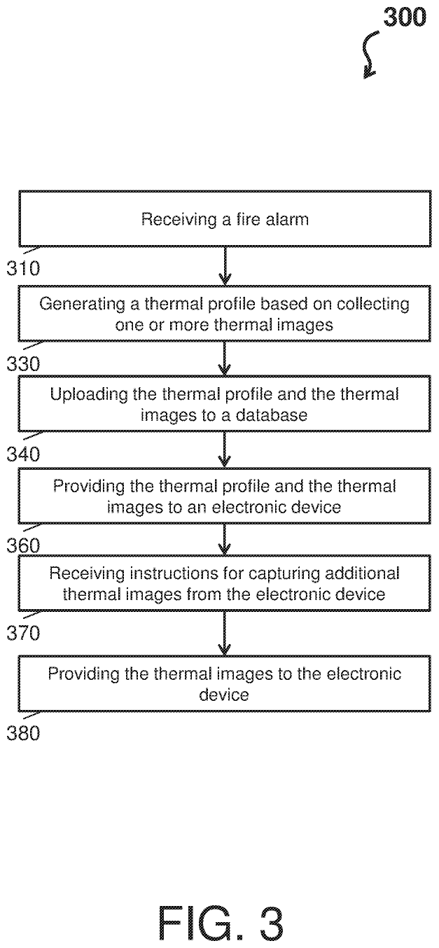

The software 160 is a set of computer readable instructions stored in the memory 132, along with an operating system, one or more application programs, other program modules, and program data. In this regard, the processor 131 executes the software 160 on the memory 132, thereby performing one or more processes defined herein. The software 160, more particularly, causes the facility management subsystem 130 to generate a thermal profile, such as is described herein with reference to FIGS. 2-3.

Turning now to FIG. 2, a process flow 200 of the system 100 is depicted for generating a thermal profile. In this regard, the system 100 can provide help to emergency personnel (e.g., a fire marshal) to ensure effective, quick, and accurate evacuation and fire suppression planning.

The process flow 200 begins at block 210, where the facility management subsystem 130 receives an alarm. The alarm can be a fire alarm generated by the fire subsystem 120, which is in communication with the facility management subsystem 130.

In response to the alarm, the process flow proceed to loop through blocks 220 and 230. At block 220, the facility management subsystem 130 instructs the detection devices 136, 138 to collect one or more images of the elevator lobbies A, B C, and D of the building and/or the hoistway 103 with respect to operations of block 230. At block 230, the facility management subsystem 130 causes the elevator 102 to automatically travel to one or more floors of the building. For example, a top of the elevator 102 can be moved to a position at an intermediate point between a top and a bottom of one of the doors A, B, C, and D. The controller 110 can cause the respective door to open, and the facility management subsystem 130 can capture an image of one of the elevator lobbies A, B, C, and D respective to that door. At block 230, the facility management subsystem 130 generates a thermal profile based on the one or more images (collected by the detection devices 136, 138).

Turning now to FIG. 3, a process flow 300 of the system 100 is depicted for generating a thermal profile. In this regard, the system 300 can provide help to emergency personnel (e.g., a fire marshal) or facility management subsystem 130 to ensure effective, quick, and accurate evacuation and fire suppression planning.

The process flow 300 begins at block 310, where the facility management subsystem 130 receives an alarm from the fire subsystem 120. At block 330, the facility management subsystem 130 generates a thermal profile based on one or more thermal images. The one or more thermal images are collected by the detection devices 136, 138 in accordance with proves flow 200, as described herein. At block 340, the facility management subsystem 130 can upload the one or more images and the thermal profile to the database 136. In accordance with one or more embodiments, blocks 310, 330, and 340 can be considered a phase-1 fire protocol where the facility management subsystem 130 and the controller 110 automatically direct the elevator to stop at designated discharge area for passenger evacuation and collect images along the way. In one example of a use case scenario, the collected images and thermal profile can be analyzed by a fire marshal or by the fire subsystem 120 to perform effective fire evacuation/suppression.

At block 360, the facility management subsystem 130 provides the thermal profile to the electronic device 150 for evaluation of the alarm. In an exemplary use case scenario, the fire marshal can be in control of the electronic device 150.

At block 370, the facility management subsystem 130 can receive instructions to capture additional images. Continuing with the exemplary use case scenario, the fire marshal can utilize the electronic device 150 to evaluate the automatically collected images and the generated thermal profile and determine where further images need to be captured. For instance, the fire marshal can review the heat zone images and data of the thermal profile. If more information regarding the alarm is required, the fire marshal can then provide a user input to the electronic device 150, which further sends instructions based on the user input to the facility management subsystem 130. The facility management subsystem 130, in turn, instructs the detection devices 136, 138 to collect the additional images in accordance with the instructions from the electronic device 150.

For instance, the facility management subsystem 130 can cause the elevator 102 to travel to different or the same floors to collect the additional images in accordance with the instructions from the electronic device 150 (e.g., from pre-programmed requirements or the user input of the fire marshal sent to the facility management subsystem 130). In accordance with one or more embodiments, the electronic device 150 can have direct control of the position of height of the elevator 102 and the counter weight 103 so that the detection devices 136, 138 are aligned at a required viewpoint to determine the severity of the alarm. The controller 110 can accordingly cause a respective door to open, and the facility management subsystem 130 can capture an image of one of the elevator lobbies A, B, C, and D respective to that door. Note that the user input can also direct the detection devices 136, 138 to move or scan. The facility management subsystem 130 can provide the additional images to the electronic device 150 for further evaluation of the alarm (e.g., by the fire marshal).

At block 380, the facility management subsystem 130 provides the thermal images to the electronic device 150. In accordance with one or more embodiments, blocks 360, 370, and 380 can be considered a phase-2 fire protocol. The phase-2 fire protocol can be a dynamic, real-time operation.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system for generating a thermal profile of a building comprising at least one elevator and at least one corresponding counterweight within a hoistway, the system comprising a facility management subsystem and one or more detection devices, the system configured to perform:
in response to receiving an alarm:
causing, by the facility management subsystem, the at least one elevator to automatically travel to one or more floors of the building, and
instructing, by the facility management subsystem, the one or more detection devices to collect one or more images of one or more elevator lobbies of the building or the hoistway with respect to the at least one elevator automatically traveling to the one or more floors; and
generating, by the facility management subsystem, a thermal profile based on the one or more images.

2. The system of claim 1, wherein the one or more detection devices comprises a first camera located on a first elevator of the at least one elevator and a second camera located on a counterweight corresponding to the first elevator.

3. The system of claim 1, wherein the facility management subsystem uploads the one or more images and the thermal profile to a database.

4. The system of claim 1, wherein the facility management subsystem provides the thermal profile to a mobile device for evaluation of the alarm.

5. The system of claim 1, wherein the facility management subsystem receives instructions, from a mobile device, to capture additional images.

6. The system of claim 5, wherein the facility management subsystem instructs the one or more detection devices to collect the additional images in accordance with the instructions from the mobile device.

7. The system of claim 6, wherein the facility management subsystem causes the at least one elevator to travel to the one or more floors to collect the additional images in accordance with the instructions from the mobile device.

8. The system of claim 7, wherein the facility management subsystem provides the additional images to the mobile device for further evaluation of the alarm.

9. The system of claim 1, wherein the one or more detection devices comprise thermographic cameras generating heat zone images as the one or more images using infrared radiation from the one or more elevator lobbies of the building or the hoistway.

10. The system of claim 1, wherein the alarm comprises a fire alarm generated by a fire subsystem in communication with the facility management subsystem.

11. A method for generating a thermal profile of a building comprising at least one elevator and at least one corresponding counterweight within a hoistway, the method being implemented by a system comprising a facility management subsystem and one or more detection devices, the method comprising:
in response to receiving an alarm:
causing, by the facility management subsystem, the at least one elevator to automatically travel to one or more floors of the building, and
instructing, by the facility management subsystem, the one or more detection devices to collect one or more images of one or more elevator lobbies of the building or the hoistway with respect to the at least one elevator automatically traveling to the one or more floors; and
generating, by the facility management subsystem, a thermal profile based on the one or more images.

12. The method of claim 11, wherein the one or more detection devices comprises a first camera located on a first elevator of the at least one elevator and a second camera located on a counterweight corresponding to the first elevator.

13. The method of claim 11, wherein the facility management subsystem uploads the one or more images and the thermal profile to a database.

14. The method of claim 11, wherein the facility management subsystem provides the thermal profile to a mobile device for evaluation of the alarm.

15. The method of claim 11, wherein the facility management subsystem receives instructions, from a mobile device, to capture additional images.

16. The method of claim 15, wherein the facility management subsystem instructs the one or more detection devices to collect the additional images in accordance with the instructions from the mobile device.

17. The method of claim 16, wherein the facility management subsystem causes the at least one elevator to travel to the one or more floors to collect the additional images in accordance with the instructions from the mobile device.

18. The method of claim 17, wherein the facility management subsystem provides the additional images to the mobile device for further evaluation of the alarm.

19. The method of claim 11, wherein the one or more detection devices comprise thermographic cameras generating heat zone images as the one or more images using infrared radiation from the one or more elevator lobbies of the building or the hoistway.

20. The method of claim 11, wherein the alarm comprises a fire alarm generated by a fire subsystem in communication with the facility management subsystem.
